(19) United States
(12) Patent Application Publication
(10) Pub. No.: US 2026/0341850 A1
(43) Pub. Date: Oct. 29, 2026

(54) SECONDARY BATTERY

(71) Applicant: Samsung SDI Co., Ltd., Yongin-si (KR)

(72) Inventors: Jea Woan LEE, Yongin-si (KR); Seung Joon LEE, Yongin-si (KR); Hiroshi Seino, Yongin-si (KR); Hee Taek LIM, Yongin-si (KR)

(21) Appl. No.: 19/317,789

(22) Filed: Sep. 3, 2025

(30) Foreign Application Priority Data
Apr. 23, 2025 (KR) 10-2025-0053081

(51) Int. Cl. H01M 50/126; B32B 7/027; B32B 15/085; H01M 50/105; H01M 50/141; H01M 50/186

(52) U.S. Cl. CPC H01M 50/126; B32B 7/027; B32B 15/085; H01M 50/105; H01M 50/141; H01M 50/186; B32B 2307/7265; B32B 2307/7376; B32B 2457/10; H01M 2220/20

(57) ABSTRACT

The secondary battery according to one or more embodiments includes a case including a housing part, a cap part, a first edge extending in a first direction, a first sealing part having a width of about 0.3 mm to about 3 mm at the first edge, a first protective layer including a moisture barrier layer on an outer surface of the first sealing part, a second edge extending in a second direction, and a second sealing part at the second edge, and an electrode assembly in the case.

### CROSS-REFERENCE TO THE RELATED APPLICATION

The present application claims priority to and the benefit of Korean Patent Application No. 10-2025-0053081, filed on Apr. 23, 2025, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a secondary battery having improved electrical capacity.

Embodiments provides a secondary battery having improved reliability.

The secondary battery according to one or more embodiments includes a case including a housing part, a cap part, a first edge extending in a first direction, a first sealing part having a width of about 0.3 mm to about 3 mm at the first edge, a first protective layer including a moisture barrier layer on an outer surface of the first sealing part, a second edge extending in a second direction, and a second sealing part at the second edge, and an electrode assembly in the case.

The first edge may include a first-first edge and a first-second edge facing in the second direction, wherein the second edge includes a second-first edge, which overlaps a lead of the electrode assembly, and a second-second edge facing in the first direction.

The first sealing part may include a first-first sealing part on the first-first edge, and a first-second sealing part on the first-second edge, wherein the second sealing part is at the second-first edge.

The first sealing part and the second sealing part may include a sealing layer.

The housing part and the cap part may include a first layer including polypropylene, a second layer on the first layer and including aluminum, stainless steel, copper, or nickel, and a third layer on the second layer and including at least one of nylon (nylon), polyethylene terephthalate (PET), or polyethylene naphthalate (PEN).

The housing part and the cap part may include a first layer including polypropylene, and a second layer on the first layer and including stainless steel, copper, or nickel.

The first protective layer may include PCTFE (Poly(chloro trifluoro ethylene)), PVDF (Poly(vinylidene)), or ETFE (Ethylene-Tetra Fluoro Ethylene Copolymer).

A thickness of the first protective layer may be about 20 μm to about 200 μm.

The first protective layer may be on an outside of the first sealing part.

The first protective layer may be on an outside of the first sealing part and on an inside of the first sealing part.

The first protective layer may be on a side of the first edge, on a bottom of the first edge, and on a top of the first edge.

The secondary battery may further include a second protective layer at the second-first edge.

The first protective layer and the second protective layer may include a same material.

The first protective layer and the second protective layer may include different respective materials.

A melting temperature of the second protective layer may be greater than a melting temperature of the first protective layer.

A melting temperature of the second protective layer may be less than a melting temperature of the first protective layer.

The secondary battery may further include a first-first protective layer at a first region of the first edge, and a first-second protective layer at a second region of the first edge, and having a different thickness than a thickness of the first-first protective layer.

The secondary battery according to one or more embodiments includes a case including a housing part, a cap part, a first edge extending in a first direction, a first sealing part at the first edge, and including a flat part having a width of about 0.3 mm to about 3 mm and a folded part, a first protective layer including a moisture barrier layer on an outer surface of the first sealing part a second edge extending in a second direction, and a second sealing part at the second edge, and an electrode assembly housed in the case.

A length of the folded part may be less than or equal to a thickness of the electrode assembly.

The first protective layer may be adhered to a lateral surface of the housing part.

### BRIEF DESCRIPTION OF THE DRAWINGS

The accompanying drawings, which are incorporated in this specification, illustrate embodiments, and serve to further illustrate the technical ideas of the disclosure in conjunction with the detailed description of embodiments that follows, and the disclosure is not to be construed as limited to what is shown in such drawings.

### In the drawings

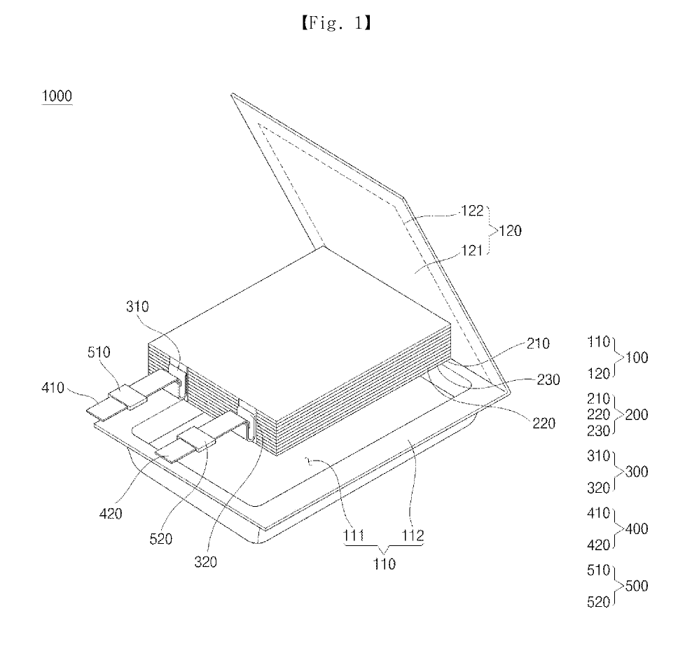

FIG. 1 is a perspective view showing a secondary battery according to one or more embodiments;

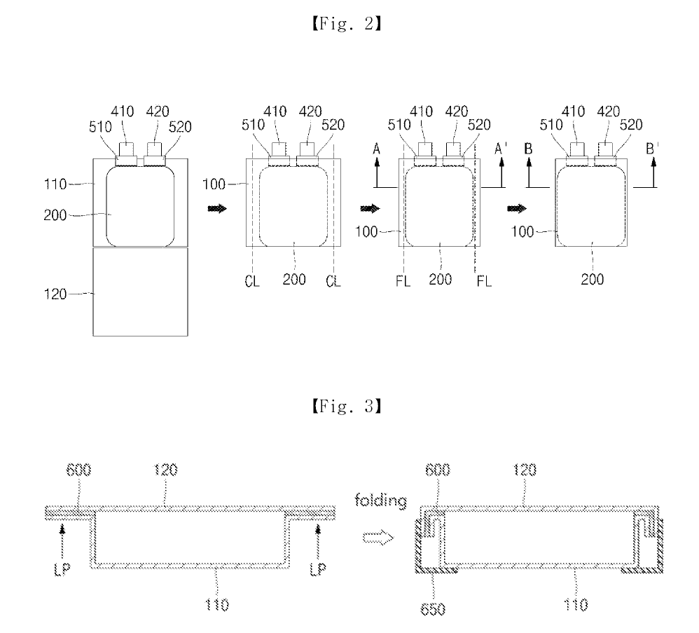

FIGS. 2 and 3 are drawings explaining a method for manufacturing the secondary battery according to one or more embodiments;

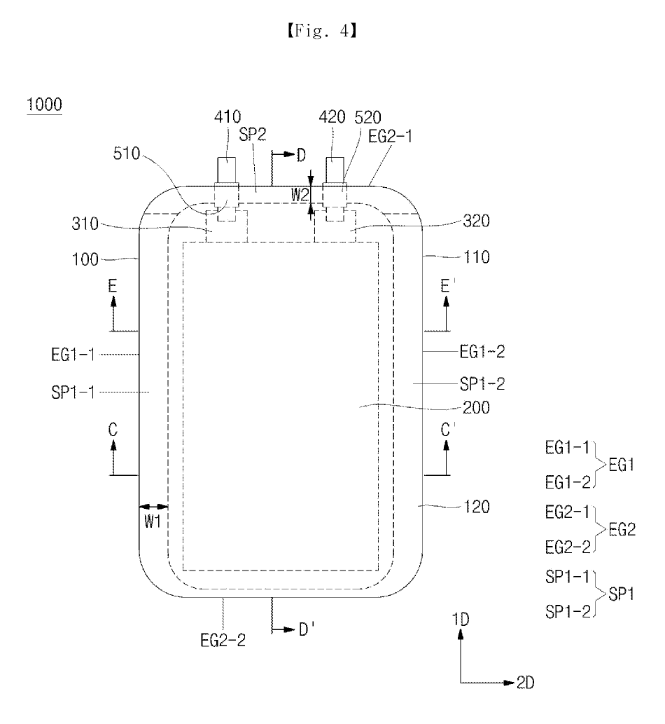

FIG. 4 is a top view showing the secondary battery according to one or more embodiments;

FIG. 5 is a cross-sectional view taken along the line C-C' of FIG. 4;

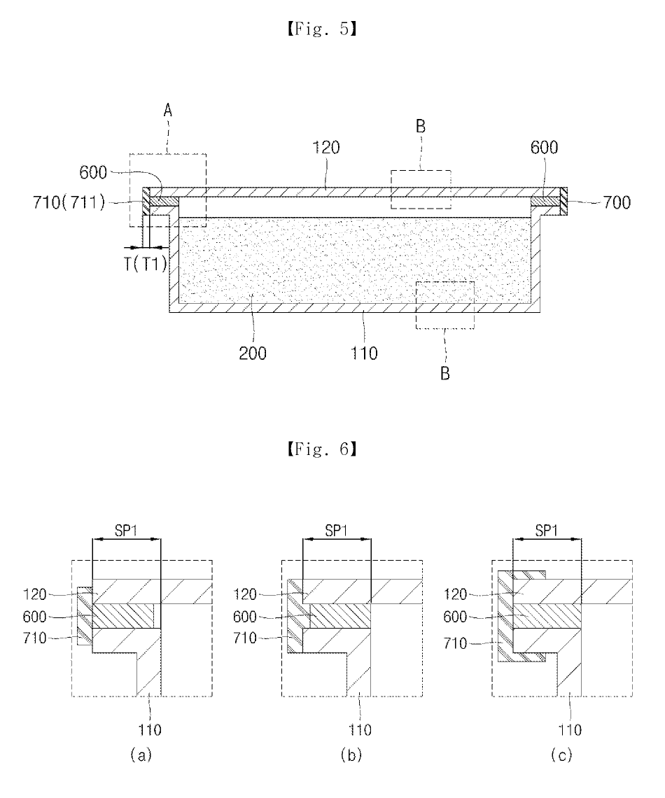

FIG. 6 is an enlarged view showing a region A of FIG. 5;

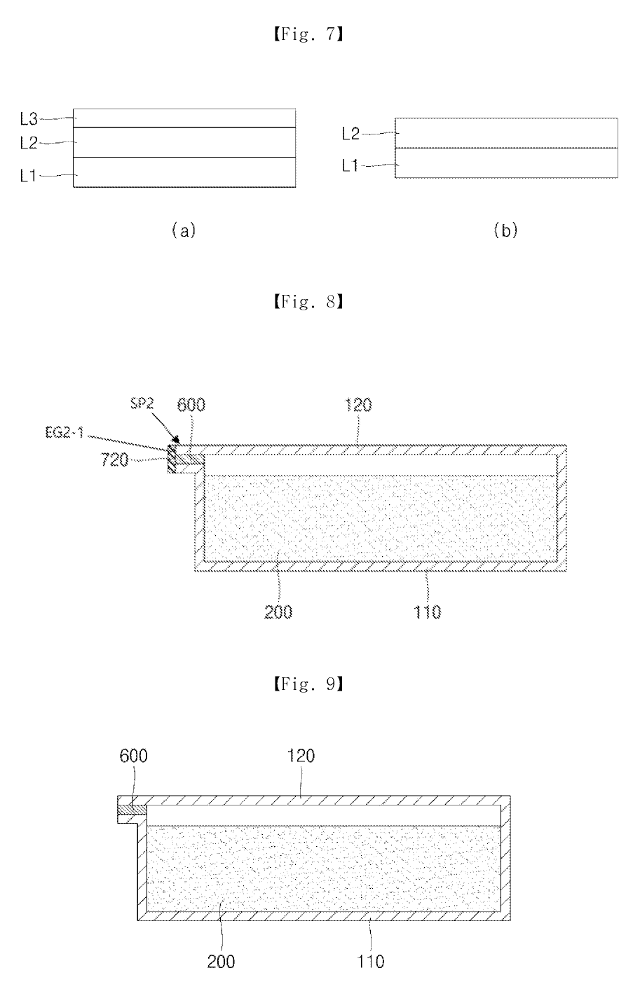

FIG. 7 is an enlarged view showing a region B of FIG. 5;

FIGS. 8 and 9 are cross-sectional views taken along the line D-D' of FIG. 4;

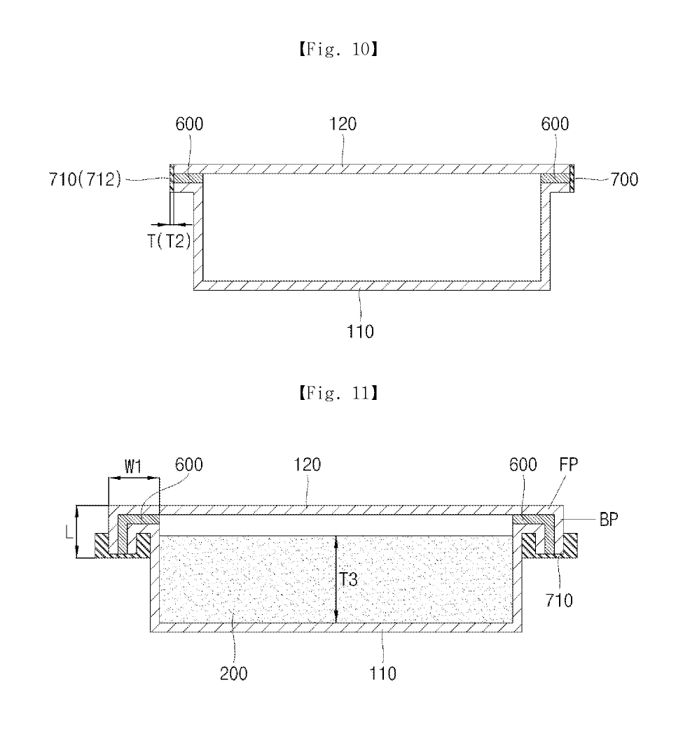

FIG. 10 is a cross-sectional view taken along the line E-E' of FIG. 4;

FIG. 11 is another cross-sectional view taken along the line C-C' of FIG. 4;

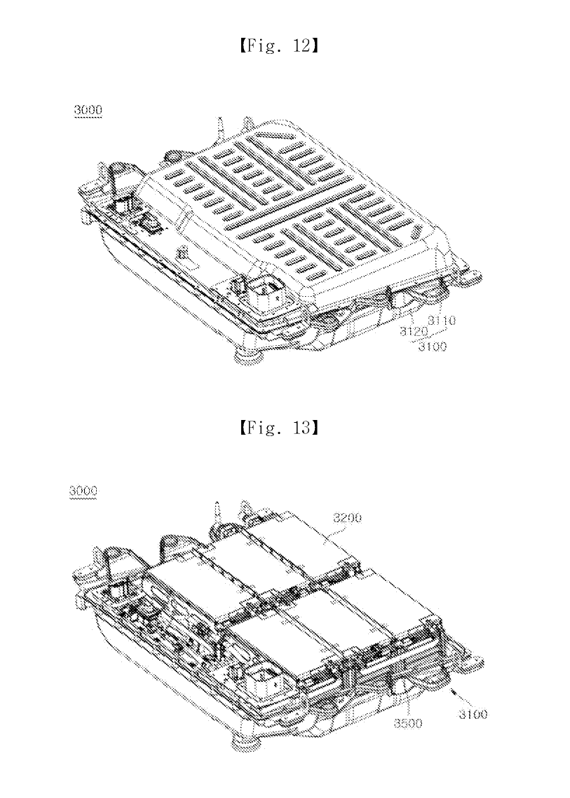

FIGS. 12 and 13 are perspective views showing a battery pack including battery modules according to one or more embodiments; and

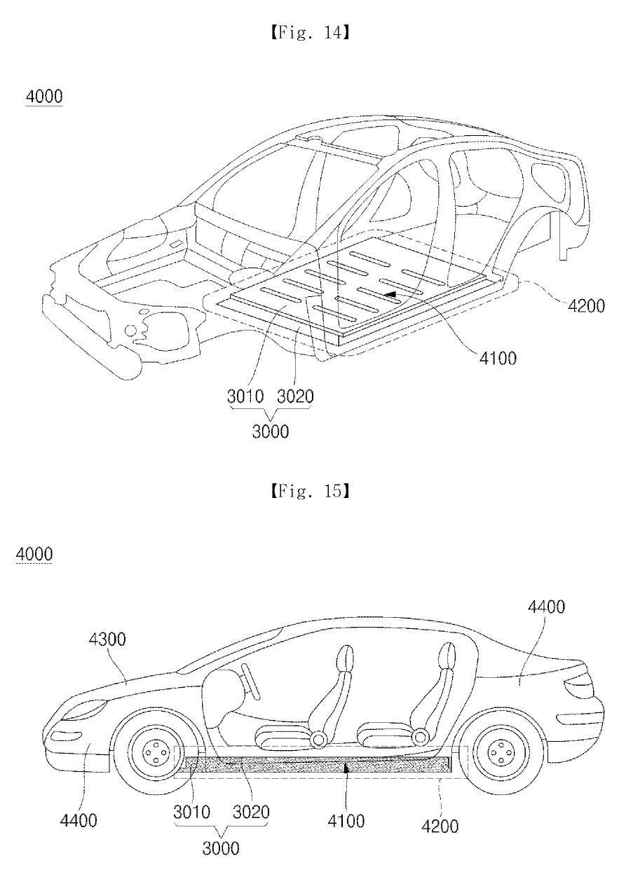

FIGS. 14 and 15 are perspective views and a side view showing a vehicle including battery packs according to one or more embodiments.

### DETAILED DESCRIPTION OF EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

When one or more embodiments may be implemented differently, a specific process order may be performed differently from the described order. For example, two consecutively described processes may be performed substantially at the same time or performed in an order opposite to the described order.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5 % or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be located in contact with the upper (or lower) surface of the element, and another element may also be interposed between the element and the arbitrary element located on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

Hereinafter, a secondary battery according to one or more embodiments will be described with reference to the drawings.

Referring to FIG. 1, a secondary battery according to one or more embodiments may include a case 100 and an electrode assembly 200.

The case 100 may include a housing part 110 and a cap part 120. The housing part 110 and the cap part 120 may be connected. The case 100 may be formed in a pouch shape.

The housing part 110 may include a concave part 111 and a first sealing region 112. The housing part 110 may include a housing space. The housing part 110 may include an internal bottom surface and an inner lateral surface formed by the concave part 111. The housing space may be formed by the internal bottom surface and the inner lateral surface.

The first sealing region 112 may be located at the edge of the housing part 110. A sealing layer may be located on the first sealing region 112.

The cap part 120 may include a cover part 121 and a second sealing region 122.

The cover part 121 may cover the housing part 110. The cover part 121 may cover the electrode assembly 200 housed in the housing part 110.

The second sealing region 122 may be located at the edge of the cap part 120. The sealing layer may be located on the second sealing region 122. The first sealing region 112 and the second sealing region 122 may overlap each other. If the housing part 110 is covered by the cap part 120, the first sealing region 112 and the second sealing region 122 may face each other. Therefore, the housing part 110 and the cap part 120 may be bonded by the sealing layer.

The electrode assembly 200 may be housed in the case 100. The electrode assembly 200 may be housed in the housing space of the case 100. The electrode assembly 200 may be housed in the housing space together with the electrolyte.

In the drawing, one electrode assembly is illustrated as being housed in the case. However, the present disclosure is not limited thereto. Two or more electrode assemblies may be housed in the case.

The electrode assembly 200 may include a first electrode 210, a second electrode 220, and a separator 230.

The first electrode 210 may include a first current collector, and a first active material layer on the first current collector. The first current collector may include a metal foil, such as aluminum or an aluminum alloy. The first active material layer may include a transition metal oxide. For example, the first electrode 210 may be a positive electrode.

The first electrode 210 may be connected to a first electrode tab 310. The first active material layer is not located on the first electrode tab 310. The first electrode tab 310 may be welded on the first current collector on which the first active material layer is not located. In one or more embodiments, the first electrode tab 310 may be formed integrally with the first current collector. For example, the first current collector may include a first uncoated portion on which the first active material layer is not located. The first uncoated portion may be notched. The first electrode tab 310 may be formed by the first uncoated portion. Therefore, the first electrode tab 310 may include the same material as the first current collector. That is, the first electrode tab 310 may be a substrate tab.

The second electrode 220 may include a second current collector, and a second active material layer on the second current collector. The second current collector may include a metal foil, such as copper, a copper alloy, nickel, or a nickel alloy. The second active material layer may include graphite or carbon. For example, the second electrode 220 may be a negative electrode.

The second electrode 220 may be connected to a second electrode tab 320. The second active material layer is not located on the second electrode tab 320. The second electrode tab 320 may be welded on the second current collector on which the second active material layer is not located. In one or more embodiments, the second electrode tab 320 may be formed integrally with the second current collector. For example, the second current collector may include a second uncoated portion on which the second active material layer is not located. The second uncoated portion may be notched. The second electrode tab 320 may be formed by the second uncoated portion. Therefore, the second electrode tab 320 may include the same material as the second current collector. That is, the second electrode tab 320 may be a substrate tab.

The first electrode tab 310 and the second electrode tab 320 may each be connected to a lead. For example, the first electrode tab 310 may be connected to a first lead 410. The first electrode tab 310 may be connected to a first external terminal by the first lead 410. The second electrode tab 320 may be connected to a second lead 420. The second electrode tab 320 may be connected to a second external terminal by the second lead 420. The first lead 410 may include the same material as the first electrode tab 310. The second lead 420 may include the same material as the second electrode tab 320. The electrode tabs 300 and the leads 400 may be respectively coupled by welding.

An insulating layer may be located on the leads. For example, a first insulating layer 510 may be located on the first lead 410. The first insulating layer 510 may surround a portion of the first lead 410. A second insulating layer 520 may be located on the second lead 420. The second insulating layer 520 may surround a portion of the second lead 420. The lead 400 may be insulated from the case 100 by the insulating layer 500. The lead 400 and the case 100 may be suitably bonded by the insulating layer 500 and the sealing layer. The first lead 410 and the second lead 420 may be insulated by the insulating layer b.

The electrode assembly 200 may be formed in a stack or winding manner. For example, the electrode assembly 200 may be formed in a Z-stack manner. The separator 230 may be supplied in a roll form, and the separator 230 may be unwound while being bent. In one or more embodiments, the separator 230 may be unwound while forming a plurality of insertion portions.

The first electrode 210 and the second electrode 220 may be sequentially inserted into the insertion portions, respectively. In one or more embodiments, the first electrode 210 and the second electrode 220 may be laminated so that the separator 230 is located between the first electrode 210 and the second electrode 220. Then, the electrode assembly 200 may be pressurized.

In one or more embodiments, the electrode assembly 200 may be formed in the winding manner. For example, the first electrode 210, the separator 230, and the second electrode 220 may be wound in one direction. In one or more embodiments, the electrode assembly 200 may be formed in a jelly-roll shape.

FIG. 2 is a drawing explaining a method for manufacturing the secondary battery according to one or more embodiments.

Referring to FIG. 2, the electrode assembly 200 is housed in the housing part 110. The electrode assembly 200 may be housed in the housing space of the housing part 110.

Next, the cap part 120 may be folded. In one or more embodiments, the cap part 120 may cover the housing part 110. That is, the electrode assembly 200 may be sealed by the cap part 120.

Next, the housing part 110 and the cap part 120 may be coupled. The first sealing region 112 and the second sealing region 122 may be bonded. For example, the first sealing region 112 and the second sealing region 122 may be thermally fused.

Next, the case 100 may be cut. The side of the case 100 may be cut. For example, the side of the case 100 may be cut along a cutting line CL to have a set width.

Next, the case 100 may be folded. The side of the case 100 can be folded, for example, along a folding line FL. In one or more embodiments, the secondary battery having a set size may be manufactured.

FIG. 3 is a drawing explaining before and after the side of the case is folded. FIG. 3 is a cross-sectional view taken along the line A-A' and B-B' of FIG. 2.

Referring to FIG. 3, the side LP of the case 100 may be folded in one direction. The side LP may be folded in a direction of the thickness of the case 100. The side LP may be bent in a direction of the lateral of the housing part 110.

Then, the bending part of the side may be fixed by a fixing member 650. The fixing member may include a tape. The fixing member 650 may be adhered to the bending part and the lower surface of the case 100.

Because the side of the case 100 is bent, the width of the case 100 may be reduced. Although the width of the case is reduced, the length of the sealing layer 600 may be maintained. In one or more embodiments, moisture flowing into the interior of the case may be blocked by the sealing layer 600. Because the length of the sealing layer 600 is increased, the inflow path of the moisture increases. Therefore, the reliability of the secondary battery may be improved.

However, the thickness of the secondary battery may be increased by the bent part. That is, if the secondary battery includes a thin film electrode assembly, the size of the case may be reduced. However, the size of the secondary battery may be increased by the bent part. The size of the secondary battery may be increased by the fixing member. In one or more embodiments, the capacity per volume of the secondary battery may be reduced.

The embodiments may include a protective layer covering the sealing part of the secondary battery. In one or more embodiments, the above problem may be solved.

Hereinafter, the secondary battery according to one or more embodiments will be described with reference to FIGS. 4 - 11.

Referring to FIG. 4, the case 100 may include a first edge EG1 extending in a first direction 1D, and a second edge EG2 extending in a second direction 2D. For example, the first direction may be a direction of the length of the secondary battery. The second direction may be a direction of the width of the secondary battery. The first edge EG1 and the second edge EG2 may be connected. As a result, an outer shape of the secondary battery may be formed.

The first edge EG1 may include a first-first edge EG1-1 and a first-second edge EG1-2. The first-first edge EG1-1 and the first-second edge EG1-2 may face each other in the second direction.

The second edge EG2 may include the second-first edge EG2-1 and the second-second edge EG2-2. The second-first edge EG2-1 and the second-second edge EG2-2 may face each other in the first direction. The insulating layer 500 may be located on the second-first edge EG2-1. That is, the lead 400 may overlap the second-first edge EG2-1. The second-second edge EG2-2 may be folded. That is, the case 100 may be folded at the second-second edge EG2-2.

The secondary battery 1000 may include a plurality of sealing parts. For example, the secondary battery may include a first sealing part SP1 and a second sealing part SP2. The first sealing part SP1 and the second sealing part SP2 may be located at different respective positions.

The first sealing part SP1 may include a first-first sealing part SP1-1 and a first-second sealing part SP1-2. The first-first sealing part SP1-1 may be located at the first-first edge EG1-1. The first-second sealing part SP1-2 may be located at the first-second edge EG1-2.

The second sealing part SP2 may be located on the second-first edge EG2-1. The sealing part may not be located on (e.g., may be omitted from) the second-second edge EG2-2.

The first sealing part SP1 and the second sealing part SP2 may be formed by the sealing layer 600 located on the first sealing region 112 and the second sealing region 122.

The sealing layer 600 may be formed by thermal fusion of the housing part 110 and the cap part 120. Referring to FIG. 7, the housing part 110 and the cap part 120 may have a multilayer structure. For example, the housing part 110 and the cap part 120 may have a two-layer structure or a three-layer structure. For example, the housing part 110 and the cap part 120 may include at least one of a first layer L1, a second layer L2, and/or a third layer L3.

Referring to part (a) of FIG. 7, the housing part 110 and the cap part 120 may include the first layer L1, the second layer L2 on the first layer L1, and the third layer L3 on the second layer L2.

The first layer L1 may be an inner layer. The first layer L1 may protect the second layer L2 from the electrolyte. The first layer L1 may be in contact with the sealing layer 600. The sealing layer 600 may be formed by the first layer L1. For example, the sealing layer 600 may be formed by thermally fusing the first layer L1 of the housing part 110 and the first layer L1 of the cap part 120.

In one or more embodiments, the sealing layer 600 may include a separate sealing material. For example, the sealing material may be located on the first sealing region 112 and/or the second sealing region 122. The sealing material may thermally fuse the first layer L1 of the housing part 110 and the first layer L1 of the cap part 120. In one or more embodiments, the sealing layer 600 may be formed.

In one or more embodiments, the housing part 110 and the cap part 120 may be sealed while being bonded. For example, at least one of the first layer L1 or the sealing material may include polypropylene.

The second layer L2 may be an intermediate layer. The second layer L2 may be located between the first layer L1 and the third layer L3. The second layer L2 may block or reduce gas or moisture that may penetrate into the interior of the case. The second layer L2 may include a metal. For example, the second layer L2 may include aluminum, stainless steel, copper, or nickel.

The third layer L3 may be an outer layer. The third layer L3 may be an outer surface of the case. Physical damage to the case, such as scratches, may be reduced or prevented by the third layer L3. The third layer L3 may serve as the insulating layer. The housing part 110 and the cap part 120 may be suitably formed by the third layer L3. The third layer L3 may include a resin. For example, the third layer (L3) may include at least one of nylon, polyethylene terephthalate (PET), or polyethylene naphthalate (PEN).

Dry lamination may be located in the between the first layer L1 and the second layer L2, or the between the second layer L2 and the third layer L3. The alignment of the layers may be controlled by the dry lamination.

Referring to part (b) of FIG. 7, the housing part 110 and the cap part 120 may include the first layer L1 and the second layer L2. That is, the housing part 110 and the cap part 120 may not include the third layer L3.

The first layer L1 may be the same as the first layer described above.

The second layer L2 may include a metal. For example, the second layer L2 may include stainless steel, copper, or nickel. Stainless steel, copper, and nickel have relatively good formability (e.g., material properties) compared to aluminum. In one or more embodiments, if the second layer L2 includes stainless steel, copper, or nickel, the third layer L3 may be omitted.

In one or more embodiments, the thickness of the housing part 110 and the cap part 120 may be reduced. That is, the thickness of the case may be reduced. That is, the electric capacity per volume of the secondary battery may be increased.

Referring to FIGS. 4 - 6, the first sealing part SP1 may have a set width. The first sealing part SP1 may have a first width W1. For example, the first width W1 may be about 3 mm or less. The first width W1 may be about 0.3 mm to about 3 mm, about 0.3 mm to about 2 mm, or about 0.3 mm to about 1 mm.

The second sealing part SP2 may have a set width. The second sealing part SP2 may have a second width W2. The second width W2 may be the same as, or similar to, the first width W1.

The internal temperature and/or pressure of the secondary battery may increase. For example, if the secondary battery is exposed to a high temperature environment, gas may be generated as the electrolyte evaporates. In one or more embodiments, the internal temperature and/or pressure of the secondary battery may increase due to the gas.

If the internal temperature and/or pressure of the secondary battery increases, the sealing layer on the second sealing part SP2 may be melted first. That is, the temperature of the second sealing part SP2 may increase due to the lead. In one or more embodiments, the second sealing part SP2 may be melted to form a vent of the secondary battery.

The first width W1 may have a set width. In one or more embodiments, the first width W1 may be formed to be about 3 mm or less. In one or more embodiments, if the internal temperature and/or pressure of the secondary battery increases, the sealing layer on the first sealing part SP1 may be suitably melted. Therefore, the sealing layer on the first sealing part SP1 may be suitably removed. In one or more embodiments, a portion of the first edge may be suitably opened. In one or more embodiments, the gas may be suitably discharged through the open region of the first edge. In one or more embodiments, the gas may be quickly discharged by the vent formed in the first sealing part and the second sealing part. In one or more embodiments, the likelihood of an explosion of the secondary battery may be reduced or prevented.

If the first width W1 exceeds about 3 mm, the size of the secondary battery may increase. A process of bending the first sealing part SP1 may be suitable to reduce the width of the secondary battery. In one or more embodiments, the manufacturing process of the secondary battery may be complicated. If the pressure and/or temperature in the secondary battery increases, the sealing layer 600 on the first sealing part SP1 may not quickly melt.

If the first width W1 is less than about 0.3 mm, the process of cutting the first sealing part may be difficult. In one or more embodiments, the manufacturing yield may decrease due to an error in the cutting process. The sealing characteristics of the case may decrease. In one or more embodiments, moisture may penetrate into the interior of the case, thereby decreasing the characteristics of the secondary battery.

The width of the first sealing part may be controlled by the first protective layer 710. The first protective layer 710 may surround an outer surface of the first sealing part SP1. In one or more embodiments, the first protective layer 710 may surround the side of the first edge EG1.

The first protective layer 710 may include a resin. The first protective layer 710 and the sealing layer 600 may include different materials. For example, the first protective layer 710 may include a resin capable of reducing or preventing moisture penetration. In one or more embodiments, the first protective layer 710 may be a moisture barrier layer. For example, the first protective layer 710 may include PCTFE (Poly(chloro trifluoro ethylene)), PVDF (Poly(vinylidene)), or ETFE (Ethylene-Tetra Fluoro Ethylene Copolymer). However, the present disclosure is not limited thereto, and the first protective layer 710 may include various materials having moisture barrier properties.

The first protective layer 710 may have a set size. For example, the first protective layer 710 may have a set thickness. For example, the thickness T of the first protective layer 710 may be about 200 ㎛ or less. The thickness T of the first protective layer 710 may be about 20 ㎛ to about 200 ㎛, about 40 ㎛ to about 150 ㎛, or about 50 ㎛ to about 100 ㎛.

The process of forming the thickness T of the first protective layer 710 to be less than about 20 ㎛ may be difficult. If the thickness of the first protective layer 710 exceeds about 200 ㎛, the size of the secondary battery may increase due to the first protective layer 710.

Referring to FIG. 6, the sealing layer 600 and the first protective layer 710 may be located in various shapes.

Referring to part (a) of FIG. 6, the sealing layer 600 may be partially located on the first sealing part SP1. The first protective layer 710 may be located on the side of the first edge EG1. In one or more embodiments, the first protective layer 710 may be located on the outside of the first sealing part SP1. The first protective layer 710 may contact the outer surface of the sealing layer 600 on the outside of the first sealing part SP1.

In one or more embodiments, the first sealing part SP1 may be sealed by the sealing layer 600. Moisture flowing into the interior of the secondary battery may be blocked by the first protective layer 710.

Referring to part (b) of FIG. 6, the sealing layer 600 may be partially located on the first sealing part SP1. The first protective layer 710 may be located on the side of the first edge EG1. In one or more embodiments, the first protective layer 710 may be located on the outside and inside of the first sealing part SP1. In one or more embodiments, the first protective layer 710 may be located while filling the first sealing part SP1 where the sealing layer 600 is not located. In one or more embodiments, the first protective layer 710 may contact the outer surface of the sealing layer 600 in the first sealing part SP1.

In one or more embodiments, the first sealing part SP1 may be sealed by the sealing layer 600 and the first protective layer 710. Moisture flowing into the interior of the secondary battery may be blocked by the first protective layer 710.

Referring to part (c) of FIG. 6, the sealing layer 600 may be located on the first sealing part SP1. The sealing layer 600 may fill the entire space of the first sealing part SP1. The first protective layer 710 may be located on the side of the first edge EG1. The first protective layer 710 may be located on at least one of the bottom or top of the first edge EG1. For example, the first protective layer 710 may be located on the side, bottom, and top of the first edge EG1. In one or more embodiments, the adhesion of the first protective layer 710 may be improved. In one or more embodiments, the likelihood of the protective layer being separated may be reduced prevented.

In one or more embodiments, the first sealing part SP1 may be sealed by the sealing layer 600. Moisture flowing into the interior of the secondary battery may be blocked or reduced by the first protective layer 710.

The first protective layer 710 may reduce or prevent moisture from penetrating into the interior of the case. In one or more embodiments, even if the size of the sealing layer 600 is reduced, moisture penetrating into the interior of the secondary battery may be reduced or prevented. In one or more embodiments, the area where the sealing layer 600 is located may be reduced. For example, the width of the first sealing part SP1 may be reduced. In one or more embodiments, the width of the first sealing part SP1 may be controlled within the above range.

Therefore, the process of bending the first sealing part SP1 may be omitted. A fixing member 650 (e.g., see FIG. 3) for fixing the bending part of the first sealing part is not required. Therefore, the size of the secondary battery may be reduced. The manufacturing process of the secondary battery may be simplified.

A second protective layer 720 may be arranged on the second edge EG2. The second protective layer 720 may be selectively arranged.

Referring to FIG. 8, the sealing layer 600 may be located on the second sealing part SP2. The second protective layer 720 may be located on the side of the second-first edge EG2-1. The second protective layer 720 may be located on the outside of the second sealing part SP2. In one or more embodiments, the second protective layer 720 may be located on the outside and inside of the second sealing part SP2. In one or more embodiments, the second protective layer 720 may be located on the side, bottom, and top of the second-first edge EG2-1.

The first protective layer 710 and the second protective layer 720 may include the same or different materials.

For example, the first protective layer 710 and the second protective layer 720 may include the same material. In one or more embodiments, the first protective layer 710 and the second protective layer 720 may be formed by the same process. Therefore, the manufacturing process efficiency of the secondary battery may be improved.

In one or more embodiments, the first protective layer 710 and the second protective layer 720 may include different materials. For example, the first protective layer 710 and the second protective layer 720 may have different melting temperatures.

For example, the melting temperature of the second protective layer 720 may be greater than the melting temperature of the first protective layer 710. The lead 400 is located at the second edge EG2. In one or more embodiments, if the secondary battery operates, the temperature of the second edge EG2 may be higher than the temperature of the first edge EG1. In one or more embodiments, the second protective layer 720 may be damaged by high temperature. In one or more embodiments, the second protective layer 720 may include a material having a relatively high melting temperature. In one or more embodiments, damage or deformation to the second protective layer 720 due to high temperature may be reduced or prevented.

In one or more embodiments, the melting temperature of the second protective layer 720 may be lower than the melting temperature of the first protective layer 710. The lead 400 is located on the second edge EG2. In one or more embodiments, if the secondary battery is exposed to a high temperature environment, the sealing layer on the second edge EG2 may be melted more quickly than the sealing layer on the first edge EG1. In one or more embodiments, the second protective layer 720 may include a material having a relatively low melting temperature. In one or more embodiments, if the sealing layer on the second edge EG2 is melted by high temperature, the second protective layer 720 may also be relatively quickly melted. In one or more embodiments, the vent of the secondary battery may be quickly opened. In one or more embodiments, the likelihood of the explosion of the secondary battery may be reduced or prevented.

Referring to FIG. 9, the sealing layer 600 may be located on the second sealing part SP2. The second protective layer 720 may not be located on, or may be omitted from, the side of the second-first edge EG2-1. The lead 400 and the insulating layer 500 are located on the second sealing part SP2. In one or more embodiments, the adhesive property of (e.g., the adhesion of) the second sealing part SP2 may be less than that of the first sealing part SP1.

In one or more embodiments, if the temperature and pressure in the secondary battery increase, the second sealing part SP2 may be opened. In one or more embodiments, the second-first edge EG2-1 may be partially opened. In one or more embodiments, gas in the secondary battery may be discharged to the outside. Because the second protective layer 720 is not located on the second-first edge EG2-1, the gas may be suitably discharged to the outside. In one or more embodiments, the likelihood of the explosion of the secondary battery may be reduced or prevented.

The thickness of the first protective layer 710 may vary depending on the location.

Referring to FIGS. 5 and 10, the location of the first protective layer may vary depending on the region. For example, a first-first protective layer 711 may be located on a first region of the first edge EG1. A first-second protective layer 712 may be located on a second region of the first edge EG1. For convenience of explanation, the first-first protective layer and the first-second protective layer are distinguished, but the first-first protective layer and the first-second protective layer may be formed integrally (e.g., may be integral).

A thicknesses of the first-first protective layer 711 and a first-second protective layer 712 may be different. For example, the thickness T2 of the first-second protective layer may be less than the thickness T1 of the first-first protective layer. For example, the thickness T2 of the first-second protective layer may be about 50 % to about 90 %, about 55 % to about 85 %, or about 60 % to about 80 % of the thickness T1 of the first-first protective layer.

A thin first-second protective layer 712 may be located in the second region of the first edge EG1. Therefore, if the temperature and pressure in the secondary battery increase, the second region of the first edge EG1 may be quickly opened. Therefore, the vent of the first sealing part SP1 may be quickly formed. In one or more embodiments, the likelihood of the explosion of the secondary battery may be reduced or prevented. Because the first protective layer is located on both the first region and the second region of the first edge EG1, penetration of moisture into the interior of the secondary battery may be reduced or prevented.

In one or more embodiments, the likelihood of the secondary battery penetrating into the interior of the secondary battery during normal operation may be reduced or prevented. If the secondary battery is exposed to a high temperature environment, the vent may be quickly opened. In one or more embodiments, the likelihood of the explosion of the secondary battery may be reduced or prevented.

In one or more embodiments, the first sealing part SP1 may be folded. FIG. 11 is another cross-sectional view taken along the line C-C' of FIG. 4.

Referring to FIG. 11, the first sealing part SP1 may be folded. In one or more embodiments, the first sealing part SP1 may include a flat part FP and a folded part (e.g., bending part) BP. The folded part BP may be folded in the direction of the thickness of the secondary battery at or near the end of the flat part FP.

The sealing layer 600 may extend along the flat part FP and the folded part BP. In one or more embodiments, the length of the sealing layer 600 may be increased. In one or more embodiments, penetration of moisture into the interior of the secondary battery may be more effectively reduced or prevented.

The flat part FP and the folded part BP may have a set size.

The flat part FP may have a first width W1. For example, the first width W1 may be about 3 mm or less. The first width W1 may be about 0.3 mm to about 3 mm, about 0.3 mm to about 2 mm, or about 0.3 mm to about 1 mm, and the size of the secondary battery need not be increased (e.g., a secondary battery of reduced size may be achieved).

The bending part BP may have a set length. For example, the length L of the bending part BP may be less than or equal to the thickness T3 of the electrode assembly. In one or more embodiments, the size of the secondary battery need not be increased due to the bending part BP.

The first protective layer 710 may be located on the outer surface of the first sealing part SP1. The first protective layer 710 may be located on the outer surface of the bending part BP. The first protective layer 710 may surround the outer surface of the bending part BP. The first protective layer 710 may be in contact with the lateral surface of the housing part 110. In one or more embodiments, the first protective layer 710 may be adhered to the lateral surface of the housing part 110. Therefore, the folded part BP may be fixed while being sealed by the first protective layer 710.

In one or more embodiments, the separate fixing member for fixing the folded part is not required, and the size of the secondary battery need not be increased due to the fixing member.

Whether the first sealing part is folded may vary depending on the usage environment of the secondary battery or depending on the thickness of the electrode assembly.

If the secondary battery is used in a general environment, the first sealing part may not be folded. In this case, the sealing layer on the sealing part having a width of about 3 mm or less and the protective layer covering the outer surface of the sealing layer may reduce or prevent moisture penetration into the secondary battery.

If the secondary battery is used in a humid environment, the first sealing part may be folded. In one or more embodiments, the length of the sealing layer may be sufficiently secured. In one or more embodiments, even if the secondary battery is exposed to a humid environment, moisture penetration into the interior of the secondary battery may be reduced or prevented.

In one or more embodiments, if the secondary battery includes an electrode assembly having a thin film thickness, the sealing part may not be folded. In one or more embodiments, the size of the secondary battery need not be increased due to the folded part.

If the secondary battery includes an electrode assembly having a large thickness, the sealing part may be folded. At this time, the length of the folded part of the sealing part may be less than or equal to the thickness of the electrode assembly. In one or more embodiments, the size of the secondary battery need not be increased due to the folded part. Moisture penetration into the interior of the secondary battery may be reduced or prevented.

The secondary battery may be used in portable small electronic devices, such as smartphones, feature phones, notebook computers, digital cameras, and camcorders. A battery module and a battery pack including a plurality of secondary batteries may be used as a power source for driving a motor of a hybrid vehicle or an electric vehicle and as a battery for storing power.

The secondary battery described above may form a battery module. For example, the battery module may include a plurality of secondary batteries. The plurality of secondary batteries may be connected to each other in series, parallel, or series/parallel by a bus bar.

FIGS. 12 and 13 show a battery pack 3000 according to one or more embodiments of the present disclosure. The battery pack 3000 may include a plurality of battery modules 3200, and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., suitable) electrical output. In the drawing, for convenience of illustration, parts (e.g., bus bars, cooling units, and external terminals for electrical connection of secondary battery) may be omitted. In one or more embodiments, battery pack 3300 may be mounted in a vehicle. The vehicle may be or may include, for example, an electric vehicle, a hybrid vehicle, or a plug-in hybrid vehicle. A vehicle may include a four-wheeled vehicle or a two-wheeled vehicle.

In FIG. 14, a battery pack 3000 may include a battery pack cover 3010, which is a part of a vehicle underbody 4100, and which may correspond to the first housing, and also may include a pack frame 3020, which is located under the vehicle underbody 4100 and may correspond to the second housing. The battery pack cover 3010 and the pack frame 3020 may be, for example, integrally formed with a vehicle floor 4200. The vehicle underbody 4100 separates the inside and outside of a vehicle, and the pack frame 3020 may be located outside the vehicle

In FIG. 15, a vehicle 4000 may be formed by combining additional parts, such as a hood 4300 in front of the vehicle 4000 and fenders 4400 that are respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above are only some embodiments for implementing a secondary battery according to the disclosure, and the disclosure is not limited to the above, and there is a technical spirit of the disclosure to the extent that various modifications can be made by anyone having ordinary skill in the art to which the disclosure pertains without departing from the gist of the disclosure.

What is claimed is:

1. A secondary battery comprising:
a case comprising:
a housing part;
a cap part;
a first edge extending in a first direction;
a first sealing part having a width of about 0.3 mm to about 3 mm at the first edge;
a first protective layer comprising a moisture barrier layer on an outer surface of the first sealing part;
a second edge extending in a second direction; and
a second sealing part at the second edge; and
an electrode assembly in the case.

2. The secondary battery as claimed in claim 1, wherein the first edge comprises a first-first edge and a first-second edge facing in the second direction, and
wherein the second edge comprises a second-first edge, which overlaps a lead of the electrode assembly, and a second-second edge facing in the first direction.

3. The secondary battery as claimed in claim 2, wherein the first sealing part comprises a first-first sealing part on the first-first edge, and a first-second sealing part on the first-second edge, and
wherein the second sealing part is at the second-first edge.

4. The secondary battery as claimed in claim 3, wherein the first sealing part and the second sealing part comprise a sealing layer.

5. The secondary battery as claimed in claim 3, wherein the housing part and the cap part comprises:
a first layer comprising polypropylene;
a second layer on the first layer and comprising aluminum, stainless steel, copper, or nickel; and
a third layer on the second layer and comprising at least one of nylon (nylon), polyethylene terephthalate (PET), or polyethylene naphthalate (PEN).

6. The secondary battery as claimed in claim 3, wherein the housing part and the cap part comprise a first layer comprising polypropylene, and a second layer on the first layer and comprising stainless steel, copper, or nickel.

7. The secondary battery as claimed in claim 1, wherein the first protective layer comprises PCTFE (Poly(chloro trifluoro ethylene)), PVDF (Poly(vinylidene)), or ETFE (Ethylene-Tetra Fluoro Ethylene Copolymer).

8. The secondary battery as claimed in claim 1, wherein a thickness of the first protective layer is about 20㎛ to about 200㎛.

9. The secondary battery as claimed in claim 1, wherein the first protective layer is on an outside of the first sealing part.

10. The secondary battery as claimed in claim 1, wherein the first protective layer is on an outside of the first sealing part and on an inside of the first sealing part.

11. The secondary battery as claimed in claim 1, wherein the first protective layer is on a side of the first edge, on a bottom of the first edge, and on a top of the first edge.

12. The secondary battery as claimed in claim 3, further comprising a second protective layer at the second-first edge.

13. The secondary battery as claimed in claim 12, wherein the first protective layer and the second protective layer comprise a same material.

14. The secondary battery as claimed in claim 12, wherein the first protective layer and the second protective layer comprise different respective materials.

15. The secondary battery as claimed in claim 14, wherein a melting temperature of the second protective layer is greater than a melting temperature of the first protective layer.

16. The secondary battery as claimed in claim 14, wherein a melting temperature of the second protective layer is less than a melting temperature of the first protective layer.

17. The secondary battery as claimed in claim 1, further comprising:
a first-first protective layer at a first region of the first edge; and
a first-second protective layer at a second region of the first edge, and having a different thickness than a thickness of the first-first protective layer.

18. A secondary battery comprising:
a case comprising:
a housing part;
a cap part;
a first edge extending in a first direction;
a first sealing part at the first edge, and comprising a flat part having a width of about 0.3 mm to about 3 mm and a folded part;
a first protective layer comprising a moisture barrier layer on an outer surface of the first sealing part
a second edge extending in a second direction; and
a second sealing part at the second edge; and
an electrode assembly housed in the case.

19. The secondary battery as claimed in claim 18, wherein a length of the folded part is less than or equal to a thickness of the electrode assembly.

20. The secondary battery as claimed in claim 18, wherein the first protective layer is adhered to a lateral surface of the housing part.
